(19) United States
(12) Patent Application Publication
(10) Pub. No.: US 2007/0075094 A1
(43) Pub. Date: Apr. 5, 2007

(54) Articulated bite valve

(76) Inventor: Dennis B. Brown, Logan, UT (US)

Correspondence Address: HOLME ROBERTS & OWEN, LLP, 299 SOUTH MAIN, SUITE 1800, SALT LAKE CITY, UT, 84111, US

(21) Appl. No.: 11/199,928

(22) Filed: Aug. 9, 2005

(51) Int. Cl. B67D 5/64; B65D 51/16

(52) U.S. Cl. 222/175; 220/202

(57) ABSTRACT

A hydration system is described, including a pouch for storing fluid, a flexible conduit connected to the pouch for delivering fluid to the user, and a jointed mouthpiece connected to the tube, the mouthpiece including at least two components connected in a moveable joint structure, one of the components being a fluid discharge element for releasing fluid from the tube. The joint structure enables the user to change the orientation of the fluid discharge element relative to the tube.

### BACKGROUND OF THE INVENTION

1. The Field of the Invention

This invention relates to hydration systems and more particularly to portable hydration pouches that may be used by cyclists, skiers and other outdoor enthusiasts.

2. The Relevant Technology

Various hydration systems have been developed for use by cyclists, skiers, hikers, and others engaged in outdoor sports and recreation. Such hydration systems also have police and military applications. In the past, the preferred method for carrying water and other fluids was a bottle or canteen. Various personal hydration systems have been developed that typically include a flexible pouch for containing fluid. The pouch is ordinarily carried in back-pack fashion on the user's back, and a flexible tube is connected to the pouch at one end, the tube having a mouthpiece including a valve or other fluid discharge device at the other end. The tube delivers fluid from the pouch to the user's mouth when the user activates the fluid discharge device.

In such hydration systems, the tube is typically of a length that extends from the bottom of the pouch on the user's back over the user's shoulder or under the user's arm to the vicinity of the user's mouth. The tube typically is connected to the pouch in the vicinity of a seam where the side walls of the pouch are joined. In other systems, the tube is connected to the pouch at a location on one of the side walls.

Various mouthpiece structures have been used in such hydration systems. When the fluid discharge device of the mouthpiece is opened, fluid is released from the mouthpiece into the user's mouth. A commonly used fluid discharge device is a bite valve, which is ordinarily activated by the user's teeth or lips. U.S. Pat. Nos. 6,039,305 and 6,032,831 provide examples of bite valves that have been developed for use in hydration systems.

The mouthpiece is ordinarily fixedly connected to the tube such that the mouthpiece is not capable of rotation, pivoting or other similar movement relative to the tube except by bending the tube. Further, where the mouthpiece is formed of two or more components, the position of these components is generally fixed so that they cannot be rotated or pivoted relative to each other or to the tube. In such systems, when the mouthpiece orientation is adjusted by the user, the consequent twisting and bending of the tube adjacent the mouthpiece can constrict the tube and hinder flow of fluid through the tube.

Current mouthpiece structures lack both a visual and tactile element that assures the user the valve is in an ON position or an OFF position. Moreover, the available valve designs are cumbersome to use, often requiring two hands to operate. Such an arrangement requires a user to stop the activity to turn the valve ON or OFF or look down to check the position of the valve and therefore risk losing concentration or control.

In addition to recreational use, the military provides hydration systems for use by its soldiers in the battlefield. Efficient systems are necessary to ensure soldiers are properly hydrated, especially in harsh environments such as the desert or high mountain areas. Many times water is in short supply, so it is imperative to ration the available water and not waste. It has been estimated that current hydration systems waste approximately 25 percent of water delivered to the soldiers in the field due to spillage as well as inefficient water delivery systems.

For both hikers and military applications, it is inefficient to take the hydration pack off to refill the water supply. Current hydration system designs require users to remove their packs or remove the bladder from their packs to fill the hydration system, for example, a back country hiker filling a hydration system in his/her backpack from a pump type water filter. Moreover, the ability to quickly disconnect and connect various terminal devices to the pack, such as filters, shower heads or the like, is a highly desirable but a currently absent or inefficient feature for present hydration systems.

### BRIEF SUMMARY OF THE INVENTION

A hydration system is described, including a pouch for storing fluid, a flexible conduit for delivering fluid from the pouch to the user, and a mouthpiece structure for facilitating the delivery of fluid from the conduit to the user's mouth. The conduit has a proximal end attachable to the pouch and a distal end that can be positioned by the user for delivery of fluid. The mouthpiece structure is connected to the distal end of the tube. In one embodiment, the mouthpiece structure includes at least two components, a valve head for passing fluid and controllable by the user to release the fluid, and a valve body for passing fluid from the tube to the valve head, the valve head and the valve body being connected by a moveable joint structure that enables the valve head to change orientation relative to the valve body.

In one arrangement, the valve head includes a plug portion coupled to a cylinder portion of the valve body. The plug portion is sized and configured to rotate within the cylinder portion, thereby providing for the rotation of the valve head relative to the valve body. A fluid discharge element rotates with the valve head as the plug portion rotates in the cylinder portion of the valve body.

In another embodiment, in the OFF or closed position, the entrance to the valve body and the exit from the valve head are in a substantially co-linear arrangement with the conduit. In this arrangement, fluid is prevented from flowing from the valve head to the valve body, and ultimately, to the users mouth. Rotating the valve head relative to the valve body from the substantially co-linear arrangement in a clockwise or counterclockwise direction to an ON or open position creates a fluid pathway. The fluid pathway allows fluid to flow from the conduit through the mouthpiece to the user. This ON/OFF arrangement provides both a visual and tactile confirmation that the valve is in an open position or closed position.

In another embodiment, the fluid discharge element comprises a bite valve attached to the valve head. The bite valve comprises a valve post and an outer sleeve and facilitates the provision of fluid from the conduit to the user.

The jointed mouthpiece of the present invention enables the user to direct the fluid discharge element to an orientation that is more comfortable, while avoiding twisting and bending of the distal end of the tube that can distort and constrict the tube and reduce fluid flow through the tube. Moreover, the jointed mouthpiece reduces the length of conduit required to reach the mouthpiece to the user's mouth, and thus the need to lengthen the conduit to the mouthpiece. Accordingly, the conduit may be shortened by anywhere from four to eight inches, resulting in a significant cost savings since the total length of tubing required for manufacturing several hundred hydration systems is greatly reduced.

In another arrangement, the conduit is attached to a quick connect apparatus. The quick connect apparatus has an inlet for coupling to the conduit and a female coupling element configured to receive a male coupling element of a connectable element. In one particular arrangement, the connectable element is a mouthpiece structure that includes at least two components, a valve body having a male coupling element detachably coupled to the female coupling element of the quick connect apparatus and a valve head for providing fluid to the user's mouth, the valve head and the valve body being connected by a moveable joint structure that enables the valve head to change orientation relative to the valve body.

The quick connect apparatus rotates relative to an axis of rotation extending through the approximate center of the opening of the conduit, the female coupling of the quick connect and the inlet to the valve body. The valve head rotates relative to the valve body around an axis of rotation extending through the approximate center of the cylinder and the plug. This arrangement provides a dual axis of rotation, one at the connection between the female coupling of the quick connect apparatus and the male coupling of the valve body and a second at the moveable joint structure coupling the valve body to the valve head.

In another embodiment, the mouthpiece structure may be disconnected from the quick connect element. This arrangement allows for the provision of one of a plurality of connectable elements to be connected to the female coupling of the quick connect. Connectible elements include any structure that may be connectable to a hydration system, such as a shower element, a water filtration system, a mobile water tank and a replacement mouthpiece structure to name a few. The connectable element is fitted with a corresponding male coupling element that is sized and configured to mate with the female coupling element of the quick connect to provide a watertight seal and therefore reduce if not eliminate the loss of fluid from the bladder.

In yet another embodiment, the quick connect element is provided with an internal valve configuration. The internal valve configuration restricts the flow of fluid through the quick connect when the quick connect is detached from a connectable element. This arrangement substantially reduces the loss of fluid from the bladder and out of the conduit when, for example, the male coupling of the mouthpiece is disconnected from the female coupling of the quick connect and, a period of time later, the male coupling of a quick connect manifold for a filling device is subsequently connected to the female coupling of the quick connect to provide fluid to the hydration system.

In another arrangement, the mouthpiece apparatus is supplied separate from the hydration system. In this arrangement, the mouthpiece structure can be used as a replacement part or adapted for use with an existing pouch and tube hydration system.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates one example of a hydration system;

FIG. 2 shows the hydration system of FIG. 1 in use;

FIG. 3 illustrates a front view of one embodiment of a mouthpiece structure;

FIG. 4 illustrates an exploded front perspective view of the components of the mouthpiece structure shown in FIG. 3;

FIG. 5 illustrates a front perspective view of an embodiment of a mouthpiece structure having a quick disconnect feature;

FIG. 6 is an exploded front perspective view of the components of the mouthpiece of FIG. 5;

FIGS. 7A through 7C illustrate the rotation of the quick disconnect feature around a first axis;

FIGS. 8 and 9 illustrate the rotation of the mouthpiece structure of FIG. 5 relative to a second axis, from a first position A to a second position B.

FIG. 10 illustrates an exploded view of an alternate embodiment of a connectable element; and

FIG. 11 illustrates a front perspective view of the connectable element of FIG. 10.

### DESCRIPTION OF A PREFERRED EMBODIMENT

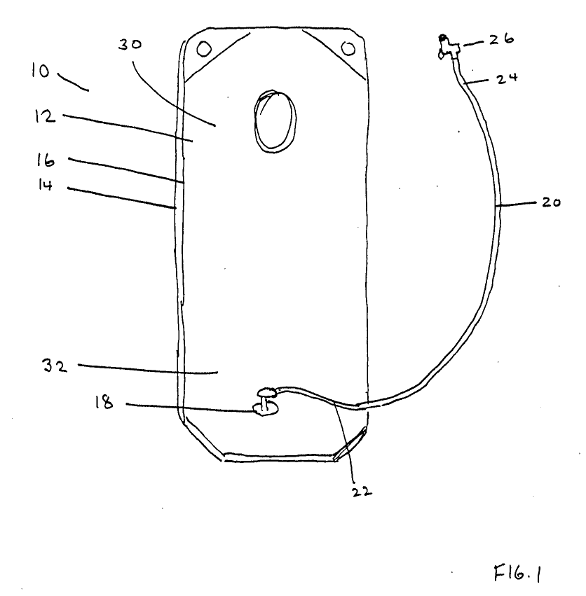

The present invention relates to portable hydration systems for storing fluid and delivering fluid to a user. FIG. 1 illustrates one embodiment of a hydration system 10. Hydration system 10 comprises a pouch or bladder 12 for storing fluid. The bladder 12 generally comprises at least two side walls—an inner side wall 14 and an outer side wall 16—and a portal 18 attached to the outer side wall 16. A flexible tube or conduit 20 is coupled to portal 18. Flexible tube 20 has a proximal end 22 that is coupled to portal 18 for receiving fluid from bladder 12 and a distal end 24 for delivering the fluid from the pouch 12 to the user. Proximal end 22 is connected to portal 18. Distal end 24 is configured to deliver fluid from the pouch to the user. In the illustrated example, a mouthpiece or bite valve 26 is connected to the distal end 24 of the tube 20 proximate the user to facilitate delivery of the fluid from the pouch 12 to a user.

In alternate hydration systems, for example, portal 18 can be located in a seam or the pouch 12 can have multiple sidewalls (not illustrated). Some embodiments of the hydration system may have one or more additional portals, one for the discharge of fluid and one for the supply of fluid. Accordingly, the present description is in no way intended to limit the invention to the pouch and tube configuration of hydration system 10 shown in FIG. 1.

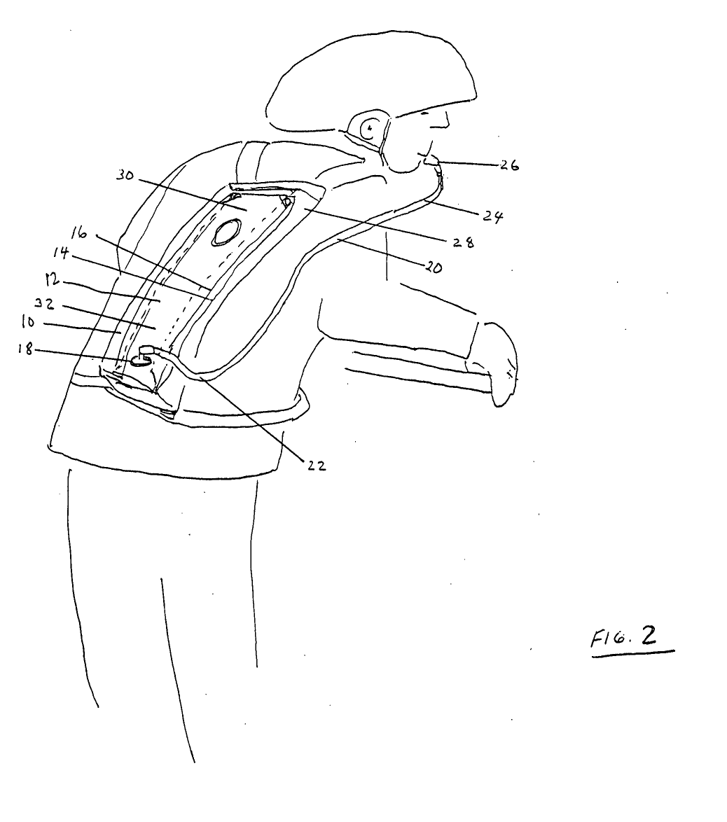

FIG. 2 illustrates the use of hydration pack 10 by a user. While the user is illustrated as a human, it is within contemplation that the hydration system 10 could be attached to different animals who may be trained to operate a bite valve which may be reconfigured for use by an animal. As shown in FIG. 2, the pouch 12 can be housed in a back pack structure 28 that is worn on a user's back. Typically, the pouch 12 has an oblong shape, and is positioned in the back pack structure 28. A top portion 30 of the pouch 12 is proximate the user's upper back. A bottom portion 32 is proximate the user's lower back. In the illustrated embodiment, the inner side wall 14 of pouch 12 is positioned adjacent a user's back and outer side wall 16 opposes the inner side wall 14 and faces in a direction generally away from the user's back.

The tube or conduit 20 is typically a hollow conduit for passing fluid from the pouch 12 to the user. The conduit 20 may be formed of any number of flexible plastic materials in any number of sizes that is currently used for a typical hydration system. In a preferred embodiment, conduit 20 is a flexible medical grade poly tubing having an outside diameter of about 0.5 inches. The bite valve 26 is secured or attached to the distal end 24. The conduit 20 is sized in length so that it will reach from a typical user's lower back to the user's mouth. In addition, the conduit 20 is formed and located such that the user can effortlessly position conduit 20 in the user's mouth when in use, or easily store conduit 20 in the back-pack structure while traveling.

While the hydration system 10 here discussed includes or is in the form of a pack, which is typically referred to as a back pack, it may be in a wide variety of forms, such as a hip type or lumbar type hydration pack. Any hydration system or apparatus will be suitable so long as it has a means for delivering fluid from a conduit to a user, as discussed hereinafter, and a container means to retain the fluid that is dispensed through the conduit for consumption.

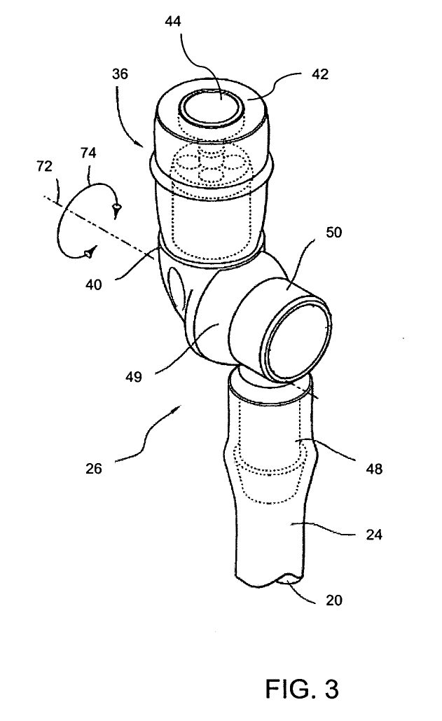

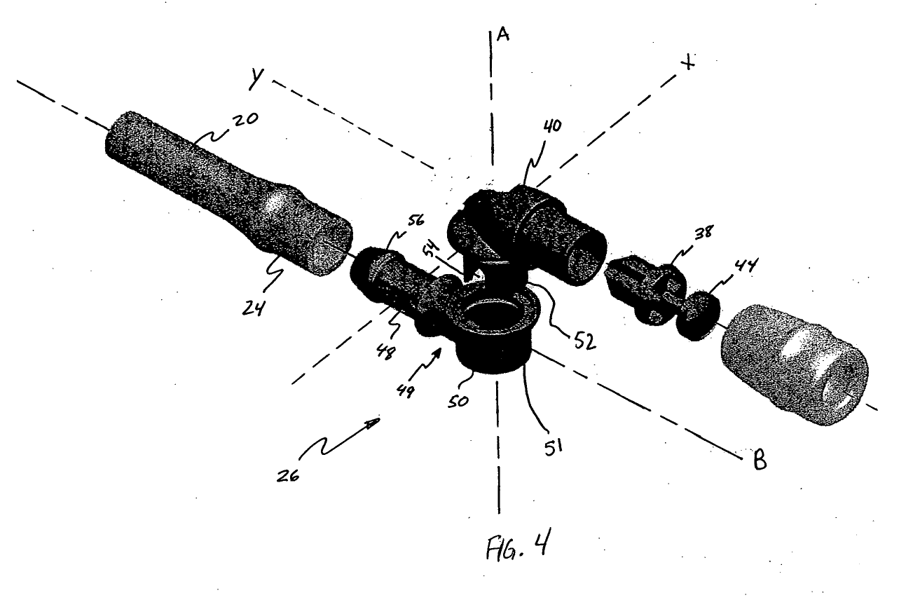

FIG. 3 illustrates one embodiment of the mouthpiece 26 connected to the distal end 24 of conduit 20. In general, the mouthpiece 26 includes a fluid discharge element 34 that controls the flow of fluid from the tube 20 to the user. In the illustrated embodiment, the fluid discharge element 34 is a bite valve comprising an outer sleeve 36 covering a valve post 38 (illustrated in FIG. 4) with a channel for communicating fluid through the discharge element to the user's mouth. To prevent the flow of fluid, the closed end 42 of the outer sleeve 36 fits snugly around the valve post end 44 of the valve post 38.

In operation, when a user bites, squeezes or otherwise causes the sleeve 36 to deform, the portion of the sleeve 36 covering the valve post end 44 collapses slightly into a slightly oblong shape. Accordingly, the end closed 42 of the outer sleeve 36 is pulled away from the valve post end 44, allowing fluid to be released from a location interior to outer sleeve 36 to the user's mouth. Other types of fluid discharge elements, such as a nipple or clamp, or a push/pull type valve that is commonly used in cycling water bottles, can be substituted for the illustrated bite valve. Accordingly, the illustrated embodiment is not intended to limit the present system to the illustrated bite valve structure.

The combination of valve head 40 and discharge element 36 rotate relative to valve body 49 in a clockwise or counterclockwise direction 74 relative to the axis of rotation 72. Axis of rotation 72 defines the axis of rotation by which valve head 40 rotates relative to valve body 49, and is defined by an imaginary line drawn through the center point of cylinder portion 50 and plug portion 52 (shown in FIG. 4), extending through both the valve body 49 and the valve head 40. In the illustrated embodiment, the movement of the valve head 40 is rotational in nature, although the joint structure can be configured to permit other forms of movement, such as a pivoting or swiveling movement of the valve head 40 relative to the valve body 49.

FIG. 4 illustrates an exploded front perspective view of the components of the mouthpiece structure 26 shown in FIG. 3. Mouthpiece 26 also includes a valve body or distal portion 49 having an inlet portion 48 that is configured for insertion into the distal end 24 of conduit 20. Inlet portion 48 has a barbed fitting 56 sized to snugly receive the distal end 24 of conduit 20 thereover. As such, the bite valve 26 may be secured or attached to the distal end 24 of conduit 20 with a watertight connection. The valve head or proximal portion 40 includes a first interior conduit (not pictured) that is interconnected with a second interior conduit (not pictured) of the valve body 49, providing a passageway for fluid to flow through the mouthpiece 26.

The valve body 49 also includes a cylinder portion 50, appropriately sized and adapted to receive the insertion of plug portion 52 of the valve head 40. The plug portion 52 and cylinder portion 50 together form a moveable joint structure, thereby pivotally connecting the valve body 49 to the valve head 40. The joint structure is configured so that the plug portion 52 can rotate within the cylinder portion 50, thereby also causing the position of the valve head 40 to change relative to the position of the valve body 49.

The valve head 40 is configured to rotate in a horizontal plane defined by an x-axis and a y-axis, as shown in FIG. 4. The horizontal plane is spaced apart from and at an angle of about 90 degrees relative to the axis A that extends perpendicular to the x-axis and y-axis through the center of cylinder portion 50 and plug portion 52 and the top of valve head 40 and the bottom of valve body 49. Axis A defines the axis of rotation by which valve head 40 rotates relative to valve body 49. In an alternate embodiment, the valve head 40 and fluid discharge element 34 can be co-linear with the valve body 49 (i.e. on the same longitudinal axis B that runs co-linear with the center of inlet 48, the center of conduit 20 and a portion of the side of cylinder portion 50). In this co-linear arrangement, the joint structure enables the valve head 40 and fluid discharge element 34 to rotate or pivot in various directions relative to the longitudinal axis B of the valve body 49.

The plug portion 52 may include one or more apertures 54 that permit fluid flow through the joint structure between valve body 49 and valve head 40 when the valve head is rotated in the horizontal x-y plane. The plug portion 52 and aperture 54 may also be configured to provide a gate mechanism or other fluid shutoff mechanism that operates as a valve and blocks or partially blocks the passage of fluid through the joint structure. Alternatively, a valve may block or partially block the flow of fluid through either the valve body 49 or valve head 40, when the valve head 40 is rotated into a selected position.

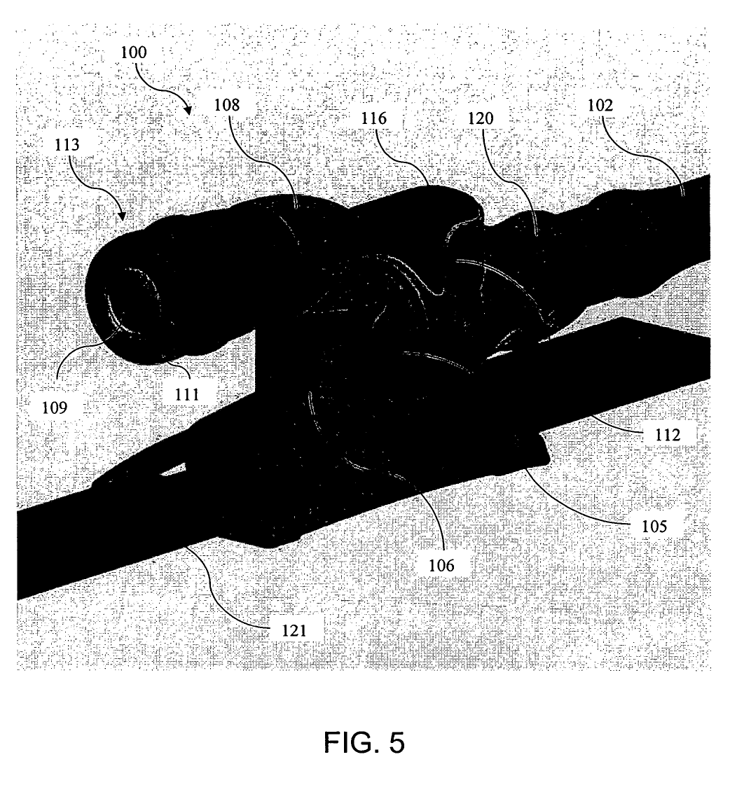

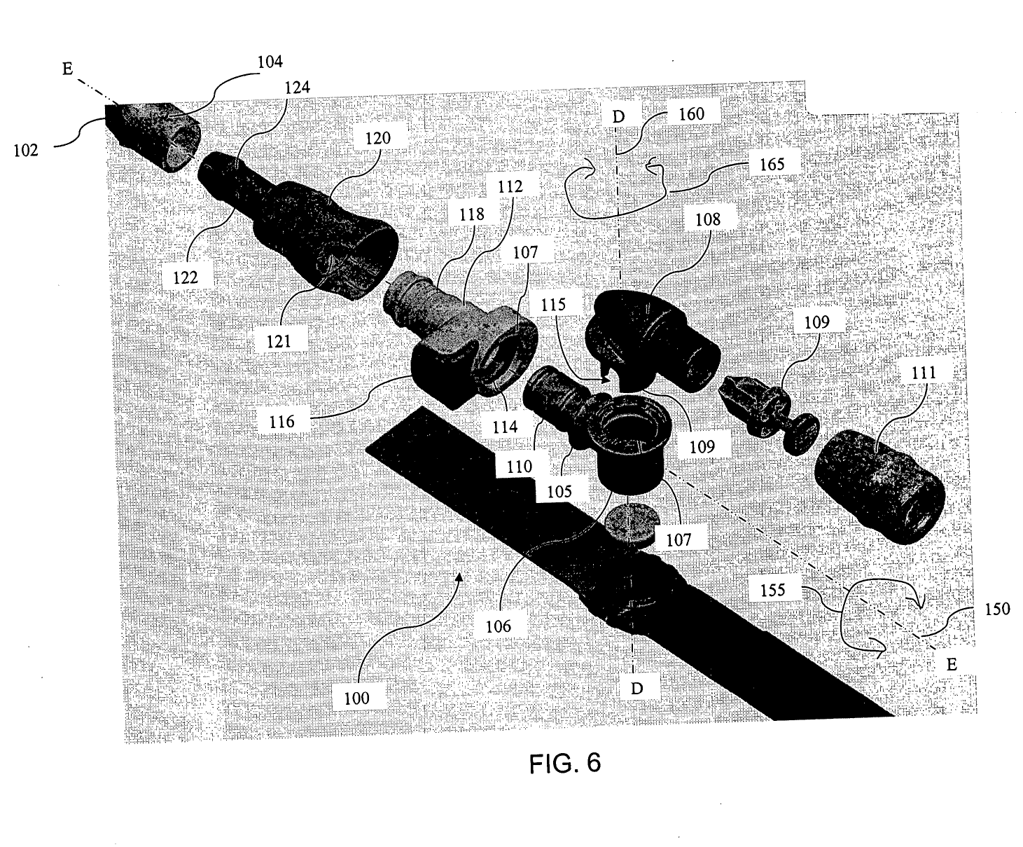

FIG. 5 illustrates a front perspective view of a preferred embodiment of a mouthpiece structure 100 connected to conduit 102 using a quick connect or quick disconnect 112. In general, mouthpiece structure 100 comprises valve body 106 with a cylinder portion 107 (shown in FIG. 6) and a valve head 108 with a plug portion 109 (shown in FIG. 6). The plug portion 109 is sized to fit with the cylinder portion 107, thereby forming a swivel joint between valve head 108 and valve body 106. The bite valve portion 113 comprises valve post 109 and sleeve 111. In operation, the bite valve portion 113 supplies fluid to the mouth of the user.

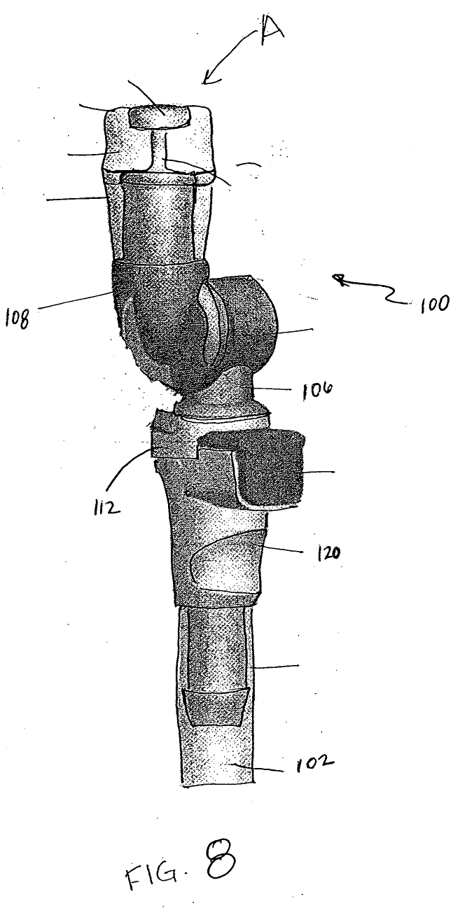

The position of proximal portion 108, and thus the bite valve portion 113, is shown as collinear with the conduit 102. In a preferred configuration, this arrangement is the OFF or closed position of the valve, since fluid is restricted from flowing from conduit 102 past valve body through valve head to bite valve portion 113, which is illustrated and described in greater detail with reference to FIG. 8. To initiate the flow of fluid, valve head 108 is rotated clockwise or counterclockwise from the illustrated co-linear position, or OFF position, to an ON or open position, thereby creating a fluid path from conduit 102 through mouthpiece structure 100 to the user's mouth, which is illustrated and described in greater detail with reference to FIG. 9.

In a preferred arrangement, valve head 108 rotates with as little force as that provided by a user's thumb. During many activities, where complete concentration and constant vision and awareness are necessary, such an arrangement alleviates the need to visually verify the valve is in the OFF or closed position. The user can simply reach down and feel the mouthpiece structure with one hand, without looking down. Accordingly, the pivoting function of the mouthpiece structure, and particularly the simple ON/OFF arrangement, provides the user with both a visual and a tactile confirmation that the valve is either in an ON position (fluid flow) or an OFF position (no fluid flow).

Mouthpiece structure 100 includes a quick connect or quick disconnect 112 that facilitates an easy connection between conduit 102 and the combination of the proximal portion 108 and the valve body 106. In a preferred embodiment, the quick connector or quick disconnect is manufactured by Colder Products, Inc. The quick connect 112 is removably coupled to an outer sleeve 120. The outer sleeve 120 provides ergonomic features that fit the contour of a user's fingers for easy handling and operation.

FIG. 6 illustrates an exploded perspective view of mouthpiece 100 and an alternate means for connecting the mouthpiece 100 to the proximal end 104 of a conduit 102. Mouthpiece 100 comprises a distal portion 106 and a proximal portion 108. The discharge element 113 has a valve post 109 and a sleeve 111 that substantially covers valve post 109 when it is inserted into proximal portion 108. A outer sleeve 120 having an inlet 122 and a barb fitting 124 is adapted to connect to the proximal end 104 of conduit 102.

In the illustrated embodiment, the hollow quick connector 112 is coupled to outer sleeve 120. Outer sleeve 120 fits the fingers of a user so that he/she may comfortable and efficiently grasp and manipulate the outer sleeve. Outer sleeve 120 has a proximal and distal end. The proximal end of the outer sleeve has an opening 121 sized and configured to receive a male portion of the quick connect 112. The quick connect 112 is therefore connected to the proximal end of the outer sleeve 120 by pressure fitting inlet 118 into opening 121. The distal end of the outer sleeve 210 has an inlet section 122 and a barbed portion 124. The inlet section is sized to receive the diameter of the distal end 104 of conduit 102 and form a tight watertight seal.

The quick connect 112 includes a spring loaded female coupling 114, that is sized and adapted for quick and easy connection and disconnection to a male coupling of a connectable element, such as inlet 110 of proximal section 106. In operation, pressing button 116 releases the lock mechanism so that inlet 110 may be inserted into spring loaded catch 114. Ridge section 105 contacts the rim portion 107 of the quick connect 112, thereby providing a stop to prevent the inlet from extending beyond the point of connection with the female coupling 114. The spring loaded mechanism of the female coupling 114 springs back again when the button 116 is released, so as to hold the inlet portion 110 of valve body 106 in place until the button 116 is depressed again. Significantly, quick connect apparatus 112 has an internal valve (not shown) that is configured to prevent the flow of fluid through the quick connect apparatus 112 when a male coupling element is disconnected from the female coupling element 114.

In the illustrated embodiment, the mouthpiece structure 100 includes at least two components, a valve body 106 having a male coupling element 110 detachably coupled to the female coupling element 114 of the quick connect apparatus 112 and a valve head 108 for providing fluid to the user's mouth. The valve head 108 and the valve body 106 are connected by a moveable joint structure that enables the valve head to change orientation relative to the valve body. The quick connect apparatus 112 rotates relative to an axis of rotation E extending through the approximate center of the opening of the conduit 102 , the female coupling of the quick connect 114, the opening 121 of the outer sleeve 120 and the inlet to the valve body 110. The valve head 108 rotates relative to the valve body 106 around an axis of rotation D extending through the approximate center of the cylinder 107 and the plug 109. This arrangement provides a dual axis of rotation, one at the point of connection between quick connect 112 and the valve body 106 and a second at the point of connection between the valve head and the valve body. Advantageously, the dual axis of rotation keeps the conduit from tangling as well as reducing the length of conduit necessary to introduce a mouthpiece to the user's mouth.

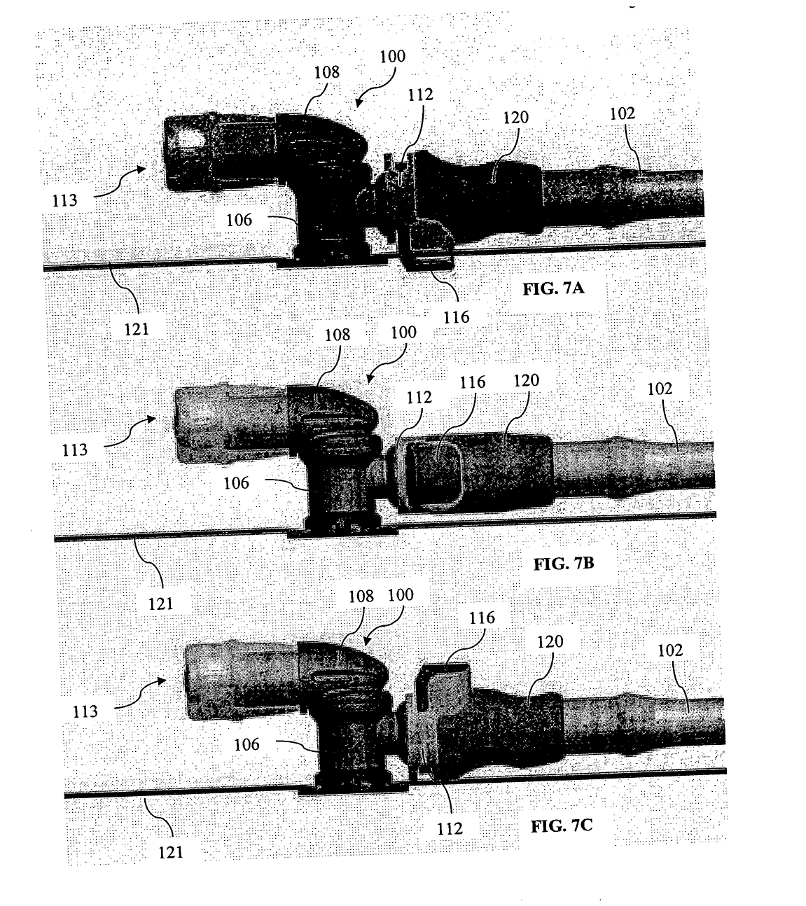

FIGS. 7A through 7C illustrate the rotational nature of the quick disconnect 112 relative to the mouthpiece structure 100. The FIGS. show the mouthpiece 100 in a fixed position for illustrative purposes only. Quick disconnect 112, outer sleeve 120 and conduit 100 are joined together in a fixed arrangement such that as quick disconnect 112 rotates, the outer sleeve 120 and conduit 100 rotate as well. FIG. 7A shows the quick disconnect 112 in a first position, with button 116 oriented downward relative to strap 120. In FIG. 7B, quick disconnect 112 rotates to a second position, with button 116 approximately 90° from the first position. In FIG. 7C, quick disconnect 112 rotates to a third position orientated upward relative to the strap 121, approximately 180° from the first position and approximately 90° from the second position.

FIGS. 8 and 9 illustrate the manner in which the fluid discharge element 113 of mouthpiece 100 shown in FIG. 5 may be rotated from a first position A shown in FIG. 8 to a second position B shown in FIG. 9. In FIG. 8, mouthpiece 100, including top valve 108 and discharge element 113, is in position A that is substantially co-linear with the conduit 102, the outer sleeve 120 and the quick connector 112. By turning handle 115, mouthpiece 100, and therefore fluid discharge element, may be rotated to a second position B that is shown in FIG. 9 as generally at a 90° relative to the co-linear elements conduit 102, outer sleeve 120 and quick connector 112. Although second position B is illustrated as generally 90°, any suitable angle may be achieved by rotating proximal portion 108 relative to distal portion 106.

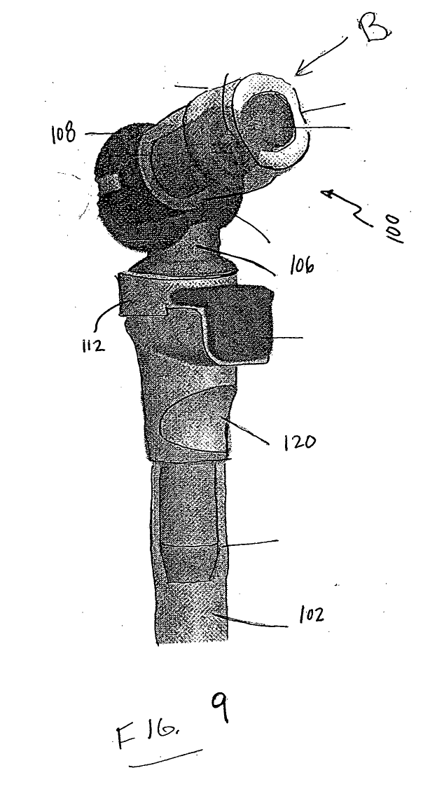

FIG. 10 illustrates an exploded front view of an alternate connectable element or mouthpiece structure 200. Mouthpiece structure 200 comprises an ON/OFF valve 215 and an outer sleeve 225 sized to snug fit over center post 205. The bite valve portion comprises valve post 205 and outer sleeve 225. The bite valve portion, when activated, supplies fluid to the mouth of the user. In general, the rotating portion of mouthpiece structure 200 comprises valve body 210 with a cylinder portion 211 and a center post 205 with a plug portion 206. The plug portion 206 is sized to fit with the cylinder portion 211, thereby forming a rotating joint between center post 205 and valve body 210. Valve body 210 is typically configured with a male coupling portion that is sized to fit with a female coupling portion of a quick connect (not shown).

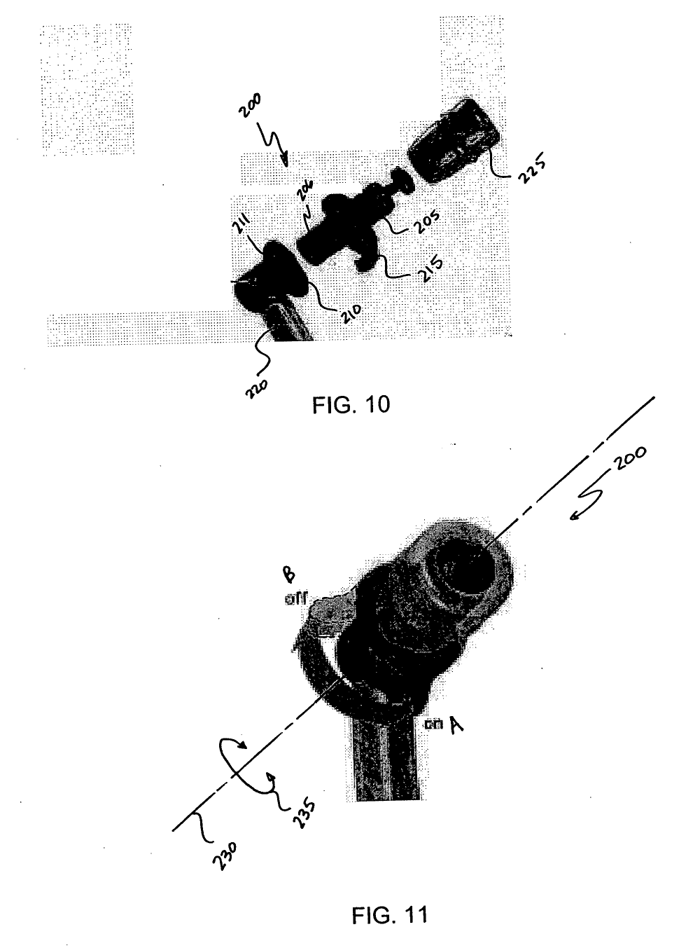

In operation, as shown in FIG. 11 the combination of center post 205 and outer sleeve 225, the valve head, rotates relative to valve body 210 in a clockwise or counterclockwise direction 235 relative to the axis of rotation 230. Axis of rotation 230 defines the axis of rotation by which the center post 205, outer sleeve 225 and ON/OFF valve 215 rotates relative to valve body 210, and is defined by an imaginary line drawn through the center point of cylinder portion 211 of valve body 210 and plug portion 206, extending through both the center post 205 and the valve body 210. In the illustrated embodiment, the movement of the center post 205 is rotational in nature from an ON position A to an OFF position B, although the joint structure can be configured to permit other forms of movement, such as a pivoting or swiveling movement of the center post 205 relative to the valve body 210.

The present embodiments illustrate an articulating mouthpiece that includes at least two components, a valve body or distal section having a means for providing pivotal connectivity relative to a valve head or proximal section having a fluid discharge element. The connectivity is such that the fluid pathway is sealed and watertight, meaning, no water escapes through the connection between the two sections. Typically, the valve body and the valve head are connected by a moveable joint structure configured such that the components can be moved by the user relative to each other. Accordingly, the fluid discharge element may be moved relative to the distal end of the conduit.

It is contemplated that, in alternate embodiments, the mouthpiece can have additional components joined in a double jointed as opposed to a single jointed structure. Further, the components can be configured to move in another fashion, such as swiveling or rotational movement relative to the distal end of a conduit, in another direction or plane, or in multiple directions or planes. The present description is not intended to limit the invention to the configurations and direction of movement described. In each of the embodiments of the illustrated hydration system, it should be noted that the user may adjust the orientation of the mouthpiece without changing the position of the distal end of the flexible conduit. Such manipulation allows a user to draw fluid from the mouthpiece without having to worry about the positioning and moving of the conduit.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A hydration system for delivering fluid to a user, said hydration system comprising:
a pouch defining a volume, said pouch being formed to contain said fluid, and said pouch having at least one side wall with an opening formed through said side wall for communicating fluid into and out of said volume;
a port connected to said side wall at said opening, said port having a proximal end and a distal end, and said port including a conduit for communicating fluid through said port to the user, said conduit having a proximal end connectable to said proximal end of said port and a distal end;
a quick connect apparatus having a inlet portion and a female coupling element, said inlet portion coupled to said distal end of said conduit, said female coupling element sized and adapted to receive and connect to a male coupling element; and
a connectable element having a male coupling element, said male coupling element being sized and configured to connect to said quick connect female coupling element, said connectable element configured for providing fluid to said pouch or extracting fluid from said pouch.

2. The hydration system of claim 1, wherein said quick connect apparatus rotates at the connection between said connectable element and said quick connect apparatus relative to an axis of rotation, said axis of rotation extending through the approximate centers of said opening at said distal end of said conduit, said opening for said quick connect female coupling and an inlet to said connectable element.

3. The hydration system of claim 2, wherein said quick connect apparatus further comprises a button and an internal valve, said button configured to connect and disconnect said male coupling element from said female coupling element, said internal valve configured to prevent the flow of fluid through said quick connect apparatus when said male coupling element is disconnected from said female coupling element.

4. The hydration system of claim 3, further comprising an outer sleeve having an opening and a sleeve inlet, said sleeve inlet coupled to said conduit, said opening coupled to said quick connect apparatus.

5. The hydration system of claim 1, wherein said connectable element is a mouthpiece structure for extracting fluid from said pouch, said mouthpiece structure comprising:
a valve head,
a valve body rotatably connected to said valve head, said valve head and said valve body configured to rotate relative to each other between an open position and a closed position, said open position for facilitating fluid flow to said valve head, said closed position for inhibiting fluid flow to said valve head,
a channel for communicating fluid through said mouthpiece structure between said valve head and said valve body, and
a discharge element operatively coupled to said valve head, said discharge element operable between a first open position for the transmission of fluid from said mouthpiece to the user and a second closed position to inhibit the transmission of fluid from said valve head.

6. The hydration system of claim 5, wherein said valve body has a male coupling element sized and configured to connect to said quick connect female coupling element, said male coupling element connected to said female coupling element.

7. The hydration system of claim 5, wherein said valve body further comprises a cylinder portion and said valve head further comprises a plug portion, wherein said plug portion is sized and configured to rotate within said cylinder portion when said valve head is coupled to said valve body, said plug portion and said cylinder portion providing said rotation of said valve head relative to said valve body.

8. The hydration system of claim 7, wherein said plug portion has at least one aperture disposed therein for facilitating the flow of fluid from said valve body to said valve head.

9. The hydration system of claim 8, wherein said aperture has a first position to prevent the flow of liquid from said valve body to said valve head, wherein said first position comprises a position where said valve head is in a substantially co-linear relationship with said valve body and said conduit.

10. The hydration system of claim 9, wherein said aperture has a second position to allow the flow of fluid from the valve body to the valve head, wherein said second position comprises a position where said valve head is rotated in a counterclockwise direction from said first position.

11. The hydration system of claim 9, wherein said aperture has a second position to allow the flow of fluid from the valve body to the valve head, wherein said second position comprises a position where said valve head is rotated in a clockwise direction from said first position.

12. A hydration system for delivering fluid to a user, said hydration system comprising:
a pouch defining a volume, said pouch being formed to contain said fluid, and said pouch having at least one side wall with an opening formed through said side wall for communicating fluid into and out of said volume;
a port connected to said side wall at said opening, said port having a proximal end and a distal end, and said port including a conduit for communicating fluid through said port to the user, said conduit having a proximal end connectable to said proximal end of said port and a distal end; and
a mouthpiece structure connected to the distal end of said conduit, said mouthpiece comprising,
a valve head,
a valve body rotatably connected to said valve head, said valve body having a male coupling element sized and configured to releasably connect to said distal end of said conduit, said valve head and said valve body configured to rotate relative to each other between an open position and a closed position, said open position for facilitating fluid flow to said valve head, said closed position for inhibiting fluid flow to said valve head,
a channel for communicating fluid through said mouthpiece structure between said valve head and said valve body, and
a discharge element operatively coupled to said valve head, said discharge element operable between a first open position for the transmission of fluid from said mouthpiece to the user and a second closed position to inhibit the transmission of fluid from said valve head.

13. The hydration system of claim 12, wherein male coupling element is sized and configured to releasably connect to a female coupling element, and wherein said hydration system further comprises a quick connect apparatus having an inlet portion and a female coupling element, said quick connect having a fluid passageway configured for transferring fluid through said quick connect, said inlet portion being releasably attachable to said distal end of said conduit and said female coupling portion being releasably attachable to said male coupling of said valve body.

14. The hydration system of claim 13, wherein said quick connect apparatus rotates at the connection between said mouthpiece structure and said quick connect apparatus relative to an axis of rotation, said axis of rotation extending through the approximate centers of said opening at said distal end of said conduit, said opening for said quick connect female coupling and an inlet to said connectable element; and wherein said valve head rotates relative to said valve body around an axis of rotation extending through said valve head and said valve body.

15. The hydration system of claim 14, wherein said quick connect apparatus further comprises a button and an internal valve, said button configured to connect and disconnect said male coupling element from said female coupling element, said internal valve configured to prevent the flow of fluid through said quick connect apparatus when said male coupling element is disconnected from said female coupling element.

16. A mouthpiece apparatus for use with a hydration system, said mouthpiece comprising:
a valve head,
a valve body rotatably connected to said valve head, said valve body having a male coupling element sized and configured to releasably connect to said distal end of said conduit, said valve head and said valve body configured to rotate relative to each other between an open position and a closed position, said open position for facilitating fluid flow to said valve head, said closed position for inhibiting fluid flow to said valve head,
a channel for communicating fluid through said mouthpiece structure between said valve head and said valve body, and
a discharge element operatively coupled to said valve head, said discharge element operable between a first open position for the transmission of fluid from said mouthpiece to the user and a second closed position to inhibit the transmission of fluid from said valve head.

17. The mouthpiece of claim 16, wherein said valve body further comprises a cylinder portion and said valve head further comprises a plug portion, wherein said plug portion is sized and configured to rotate within said cylinder portion when said valve head is coupled to said valve body, said plug portion and said cylinder portion providing said rotation of said valve head relative to said valve body.

18. The mouthpiece of claim 17, wherein male coupling element is sized and configured to releasably connect to a female coupling element, and wherein said mouthpiece apparatus further comprises a quick connect apparatus having an inlet portion and a female coupling element, said quick connect having a fluid passageway configured for transferring fluid through said quick connect, said inlet portion being releasably attachable to said distal end of said conduit and said female coupling portion being releasably attachable to said male coupling of said valve body.

19. The mouthpiece of claim 18, wherein said quick connect apparatus rotates at the connection between said mouthpiece structure and said quick connect apparatus relative to an axis of rotation, said axis of rotation extending through the approximate centers of an opening at said distal end of said conduit, an opening for said quick connect female coupling and an inlet to said connectable element; and wherein said valve head rotates relative to said valve body around an axis of rotation extending through said valve head and said valve body.

20. The mouthpiece of claim 19, further comprising an outer sleeve having an opening and a sleeve inlet, said sleeve inlet coupled to said distal end of said conduit, said opening coupled to said quick connect inlet portion, wherein said outer sleeve comprises a plurality of ergonomic impressions for providing a user of said hydration system with positions for grasping said outer sleeve.
